(19) United States
(12) Patent Application Publication
(10) Pub. No.: US 2024/0009898 A1
(43) Pub. Date: Jan. 11, 2024

(54) Apparatus and Method for Rotationally Molding an Item

(71) Applicant: Cambro Manufacturing Company, Huntington Beach, CA (US)

(72) Inventors: Chuck Adams, Lake Elsinore, CA (US); Jeff Nicholson, Long Beach, CA (US)

(21) Appl. No.: 17/860,758

(22) Filed: Jul. 8, 2022

(51) Int. Cl. B29C 41/38; B29C 41/04; B29C 41/46; B29C 41/42

(52) U.S. Cl. CPC B29C 41/38; B29C 41/04; B29C 41/46; B29C 41/42

(57) ABSTRACT

A plate assembly for increasing the efficiency and safety of a rotational molding machine. The plate assembly includes a mold plate that is coupled to a mold and mold frame, and an arm plate that is coupled to a distal end of rotating arm portion of the rotational molding machine. The mold plate includes means for being rotated relative to the arm plate that the mold plate may be selectively engaged to the arm plate. The mold plate and by extension the mold are locked into position via a plurality of coupling means disposed on the arm plate. Once secured, the rotational molding process is carried out by the rotational molding machine rotating the mold and plate assembly around at least one axis of rotation as the mold is indexed or rotated through each of the plurality of fabrication steps.

### BACKGROUND

### Field of the Technology

The invention relates to the field of rotational molding, specifically apparatus and methods for rotationally molding items or objects comprised of plastic or plastic composites.

### Description of the Prior Art

The process of rotational molding, or rotomolding, has long been used in the manufacturing business to fabricate everything from automotive parts to agricultural storage tanks. Any product which may be too large for other processes such as injection molding which require a hollow interior are often best suited for rotomolding.

Typically, the rotomolding process starts with a hollow mold of the item to be fabricated being filled or charged with plastic which, depending on the type of mold being used, may be in the form of a liquid or powdered resin or a plurality of plastic pellets. The mold is disposed on a mold frame which itself is disposed on a rotational arm which is capable of rotating or spinning the mold frame along at least two different axes of rotation as the mold frame is warmed using an oven or other heating element. The rotation arm continues to spin the mold as the resin or pellets disposed therein begin to melt and then coat the inner surfaces of the mold. After a predetermined amount of time, the mold frame is removed from the oven while the rotational arm continues to rotate the mold. Once sufficiently cooled, the rotational arm stops spinning the mold. The mold is then opened, allowing the now fabricated item to be removed. The entire procedure may then be repeated by then refilling or recharging the mold with new plastic resin or plastic pellets and restarting the rotating and heating process.

While rotational molding can produce nearly any type of product imaginable, a problem develops however when the mold itself needs recharging or when a mold is to be replaced by a different mold within the rotomolding machine so that a different product may be manufactured. Molds used in the rotational molding process need to be thick and as a result are extremely heavy and must be carefully lifted using hoists or cranes each time one is to be removed or installed. Once guided into position, one or more workers must then physically couple the mold to the mold frame by most frequently using a plurality of bolts and a pneumatic wrench. The workers must get extremely close to the mold including often climbing or ducking underneath the mold in order to properly tighten each bolt. This can be highly dangerous for the worker since even a relatively small mold could cause great pain or injury if it fell while the worker was attempting to couple it to its corresponding mold frame. This risk is only increased when multiple products need to be manufactured within a short amount of time and workers must rush each installation or removal process.

What is needed therefore is improved apparatus and method for installing and removing molds from rotational molding machines and devices. The apparatus and method should be easy to use and implement and should increase the overall safety of those workers or employees tasked with recharging or replacing the mold while also reducing any down time for the rotational molding machine whenever a mold is being replaced.

### BRIEF SUMMARY

The current invention provides an apparatus for coupling a mold to a rotational molding machine. The apparatus includes an arm plate and a mold plate that is configured to accommodate and rotate about a raised portion of the arm plate that is removably disposed within a body of the mold plate. The arm plate also includes a plurality of hand actuated or manual coupling means that are configured to selectively lock the mold plate to the arm plate.

In one embodiment, the raised portion of the arm plate includes a raised platform while the mold plate includes an opening that is defined within the body of the mold plate which is configured to accommodate the raised platform of the arm plate.

In another embodiment, the apparatus also includes a plurality of rods that are symmetrically disposed on the body of the mold plate as well as a plurality of receivers that are symmetrically disposed on the arm plate, each of the receivers having at least one of the hand actuated or manual coupling means disposed thereon. Each of the plurality of receivers includes a strike aperture that is defined therein which is configured to accommodate at least one of the plurality of rods.

In another embodiment, each of the plurality of hand actuated or manual coupling means includes both a lever and a clasp, where the clasp is configured to capture the mold plate.

In yet another embodiment, the mold plate has at least one mounting bracket that is configured to couple the mold plate to a mold frame and/or a mold.

In a further embodiment, the arm plate also includes means for coupling to a distal end of a rotational arm of the rotational molding machine.

The current invention also provides a rotational molding apparatus which includes a mold, an indexing unit having at least one rotational arm, a mold plate coupled to the mold, and an arm plate coupled to a distal end of the at least one rotational arm. The mold plate itself includes means for selectively engaging the arm plate in order to couple the mold to the at least one rotational arm.

In one embodiment, the means for selective engaging the arm plate in order to couple the mold to the at least one rotational arm includes an aperture defined within a body of the mold plate and a raised platform that is disposed on the arm plate, the raised platform being configured to fit within the opening defined in the body of the mold plate. Here, the mold plate is specifically configured to rotate relative to the arm plate when the raised platform is disposed within the aperture.

In a further embodiment, the means for selectively engaging the

arm plate in order to couple the mold to the at least one rotational arm specifically includes a plurality of rods that are disposed on the mold plate and a plurality of receivers that are disposed on the arm plate, each of the plurality of receivers having a strike aperture defined therein. The means for selectively engaging also include a hand actuated or manual coupling means that are disposed on each of the plurality of receivers. The strike aperture defined in each of the plurality of receivers is configured to accommodate at least one of the plurality of rods therein. Specifically, the hand actuated or manual coupling means of this embodiment may comprise a toggle clamp. Additionally, both the plurality of rods and the plurality of receivers are preferably symmetrically disposed around the mold plate and the arm plate, respectively. Additionally in this embodiment, the toggle clamp may further include a clasp that is configured to fit around a head of at least one of the plurality of rods. The plurality of rods and the plurality of receivers preferably extend radially from a body of the mold plate and a body of the arm plate, respectively.

In yet a further embodiment, the mold and mold plate are specifically configured to rotate around a primary axis and a secondary axis while the mold plate is selectively engaged with the arm plate.

The current invention further provides a method for coupling a mold to a rotational molding machine. The method includes disposing a mold plate that is coupled to a mold over an arm plate that is coupled to a distal end of at least one rotational arm of the rotational molding machine, inserting a platform that is disposed on the arm plate into an aperture defined in a body of the mold plate, and then rotating the mold plate relative to the arm plate. Next, the mold plate is locked to the arm plate.

In one particular embodiment, rotating the mold plate relative to the arm plate specifically includes rotating the body of the mold plate around a circumference of the platform disposed on the arm plate.

In a separate embodiment, rotating the mold plate relative to the arm plate includes rotating a plurality of rods that are radially disposed on the body of the mold plate relative to the arm plate. More specifically, rotating the plurality of rods radially that are disposed on the body of the mold plate relative to the arm plate includes rotating the plurality of rods into a corresponding plurality of receivers disposed on the arm plate, namely by preferably inserting each of the plurality of rods into an aperture that is defined in each of the plurality of receivers. In this embodiment, locking the mold plate to the arm plate specifically includes actuating a coupling means that is disposed on each of the plurality of receivers after the mold plate has been rotated relative to the arm plate. Additionally, the step of actuating the coupling means disposed on each of the plurality of receivers after rotating the mold plate relative to the arm plate preferably includes accommodating each of the plurality of rods with a clasp that is disposed on each of the plurality of receivers and then maintaining the plurality of rods in a fixed position relative to the plurality of receivers.

In yet another embodiment, the method also includes coupling the mold plate to a mold frame.

The current invention further provides a method for manufacturing

an item using a rotational molding machine. The method includes charging a mold with granulated plastic, disposing a mold plate that is coupled to the mold on top of an arm plate that coupled to a distal end of a rotational arm of a rotational molding machine, and then rotating the mold relative to the rotational arm in a first direction. A coupling means disposed on the arm plate is then actuated which locks the mold plate to the arm plate. Next, the rotational molding process is carried out by first heating the mold while rotating the mold along a primary axis and a secondary axis and then cooling the mold while rotating the mold along the primary axis and the secondary axis. After cooling, the item is removed from the rotational molding machine.

In one embodiment, disposing the mold plate that is coupled to the mold on top of the arm plate that is coupled to the distal end of a rotational arm of the rotational molding machine specifically includes aligning an aperture that is defined in a body of the mold plate over a platform disposed on the arm plate and then inserting the platform disposed on the arm plate into the aperture that is defined in the body of the mold plate. More specifically, rotating the mold relative to the rotational arm in the first direction includes rotating the body of the mold plate around a circumference of the platform of the arm plate.

In a separate embodiment, rotating the mold relative to the rotational arm includes inserting a plurality of rods that are disposed on the mold plate into a corresponding plurality of receivers that are disposed on the arm plate as the mold plate is rotated relative to the arm plate.

In yet a further embodiment, the method of step of actuating the coupling means disposed on the arm plate which locks the mold plate to the arm plate specifically includes actuating a plurality of toggle clamps.

In another embodiment, the step of actuating the coupling means disposed on the arm plate includes inserting each of the plurality of rods into a strike aperture that is defined in each of the corresponding plurality of receivers, disposing a clasp that is disposed on each of the plurality of receivers around each of the plurality of rods, and then tightening the clasp disposed on each of the plurality of receivers against a surface of each of the plurality of receivers.

In one embodiment, removing the item from the mold includes actuating the coupling means disposed on the arm plate which unlocks the mold plate from the arm plate, rotating the mold relative to the rotational arm in a second direction, and then lifting the mold plate from the arm plate. The fabricated item is then removed from the mold. Lifting the mold plate from the arm plate may also preferably include removing a platform that is disposed on the arm plate from an aperture that is defined within a body of the mold plate.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1A is a perspective view of the current invention comprising an arm plate and a mold plate, with mold plate separated from and disposed at an offset angle relative to the arm plate.

FIG. 1B is a side view of the arm plate and mold plate seen in FIG. 1A.

FIG. 2A is a top down view of the current invention after the mold plate has been coupled to the arm plate at an offset angle relative to the arm plate.

FIG. 2B is a top down view of the mold plate and arm plate seen in FIG. 2A after the mold plate has been rotated relative to the arm plate and then locked to the arm plate.

FIG. 3A is a perspective view of the mold plate coupled to the arm plate seen in FIG. 2B.

FIG. 3B is a side view of the mold plate coupled to the arm plate seen in FIG. 3A.

FIG. 4 is an exploded view of the mold plate and arm plate seen in FIG. 1A along with a mold and mold frame.

FIG. 5 is a partial exploded view of the mold plate and arm plate seen in FIG. 4 after the mold plate has been coupled to the mold frame.

FIG. 6A is a perspective view of the current invention with the mold, mold frame, and mold plate coupled to the arm plate seen in FIG. 5 when the mold plate is disposed at an offset angle relative to the arm plate.

FIG. 6B is a magnified view of one of the rods of the mold plate and a toggle clamp of the arm plate seen in FIG. 6A. The mold plate is seen in an open configuration and unlocked from the arm plate.

FIG. 7A is a perspective view of the current invention with the mold, mold frame, and mold plate coupled to the arm plate seen in FIG. 6A after the mold plate has been rotated relative to the arm plate and then locked to the arm plate.

FIG. 7B is a magnified view of one of the rods of the mold plate within a toggle clamp of the arm plate seen in FIG. 7A. The mold plate is seen in a closed configuration and locked to the arm plate.

FIG. 8A is a perspective view of the current invention with the mold, mold frame, and mold plate coupled to the arm plate as seen in FIG. 6A after the coupling means disposed on the arm plate have been actuated and the mold plate has been rotated in a second direction relative to the arm plate.

FIG. 8B is a magnified view of one of the receivers seen in FIG. 8A. The mold plate is seen in an open configuration after being unlocked from the arm plate.

FIG. 9 is a perspective view of the current invention seen in FIGS. 5-8B after the mold, mold frame, and mold plate have been lifted from the arm plate.

FIG. 10 is an exploded view of a distal end of a rotational arm portion of a rotational molding machine incorporating the mold plate and arm plate of the current invention.

FIG. 11 is a perspective view of the distal end of the rotational arm portion of a rotational molding machine incorporating the mold plate and arm plate of the current invention seen in FIG. 10.

FIG. 12A is a top down view of the distal end of the rotational arm portion of a rotational molding machine incorporating the mold plate and arm plate of the current invention seen in FIG. 10 with the mold and mold frame removed for clarity. The mold plate is seen being locked to the arm plate through a plurality of coupling means disposed symmetrically around the arm plate.

FIG. 12B is a perspective view of the distal end of the rotational arm portion of a rotational molding machine incorporating the mold plate and arm plate of the current invention seen in FIG. 12A.

FIG. 13A is a top down view of the distal end of the rotational arm portion of a rotational molding machine incorporating the mold plate and arm plate of the current invention seen in FIG. 10 with the mold and mold frame removed for clarity. The mold plate is seen being unlocked from the arm plate and rotated into an open position relative to the arm plate.

FIG. 13B is a perspective view of the distal end of the rotational arm portion of a rotational molding machine incorporating the mold plate and arm plate of the current invention seen in FIG. 13A after the mold plate has been decoupled from the arm plate and then removed from the distal end of the rotational arm portion of the rotational molding machine.

FIG. 14 is a partially exploded perspective illustration of a rotational molding machine including an indexing unit, a loading/unloading station, an oven, a first cooler, and a second cooler. The indexing unit comprises a plurality of molds, each with its own corresponding mold plate and arm plate of the current invention.

FIG. 15A is a perspective illustration of an alternative embodiment of a rotational molding machine including an indexing unit, a loading station, an unloading station, an oven, an ambient cooling zone, and a cooler. The indexing unit comprises a plurality of molds, each with its own corresponding mold plate and arm plate of the current invention.

FIG. 15B is a magnified view of one of rotational arms and one of the molds seen in FIG. 15A.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

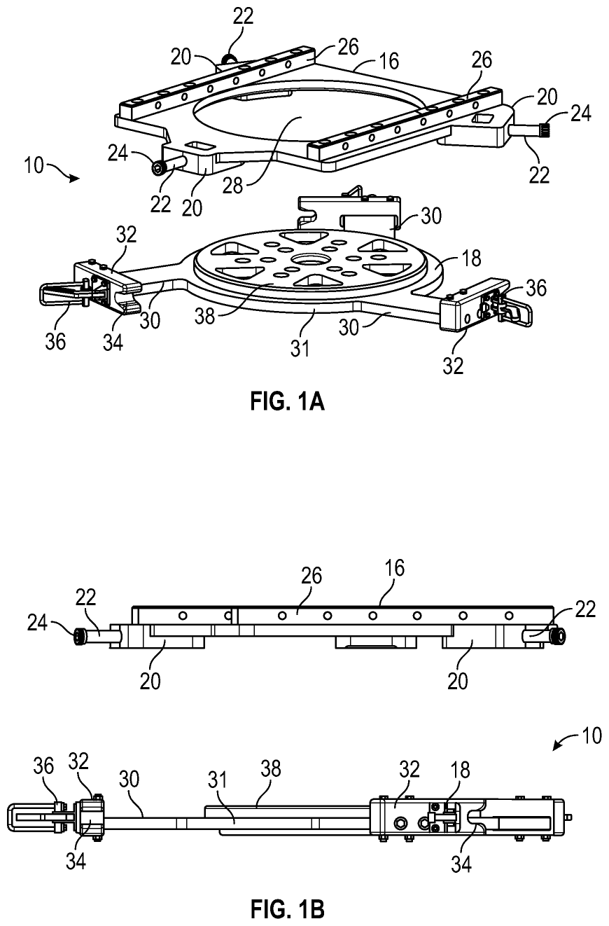

Greater understanding of the current invention and its various embodiments may be had by turning to FIGS. 1A and 1B which denotes the plate assembly for a mold generally with reference numeral 10. The plate assembly 10 comprises a mold plate 16 and an arm plate 18 which are each configured to interact or engage with one another in order to provide an easy and safe method for installing and removing a mold from a rotational molding machine.

The mold plate 16 comprises a substantially rectangular body with a plurality of radial protrusions or spokes 20 emanating from a center of mass of the mold plate 16. Disposed in turn on each of the plurality of radial protrusions or spokes 20 is a bolt or rod 22 which extends horizontally outward from the mold plate 16. Each bolt or rod 22 may also comprise an enlarged cap or head 24 which comprises a slightly larger diameter relative to the rest of the bolt or rod 22. Disposed on an upper or top surface of the mold plate 16 are a plurality of mounting brackets or rails 26. Each of the mounting brackets or rails 26 comprise a plurality of apertures which permit a number of bolts, screws, or other means for coupling as is known in the art. Defined in the center of the mold plate 16 is a substantially circular aperture or opening 28 which is configured to accommodate a portion of the arm plate 18 as detailed further below.

The arm plate 18 is substantially circular in shape and like the mold plate 16, comprises a corresponding plurality of radial protrusions or spokes 30 emanating from a body 31. Disposed on the distal end of each of the plurality of radial protrusions or spokes 30 is a terminal or receiver 32 which itself comprises a substantially semi-circular or crescent shaped strike aperture 34 defined through the terminal or receiver 32 on at least one lateral edge or side. Coupled to a front or forward facing surface of each of the terminals or receivers 32 is a toggle clamp or other coupling means 36. In the center of the arm plate 18 is a raised or elevated platform or disc 38 which extends upward from the body 31 of the arm plate 18. The platform or disc 38 is substantially circular and is sized and shaped to tightly fit within or be accommodated within the aperture or opening 28 of the mold plate 16 as is discussed in further detail below.

Both the mold plate 16 and the arm plate 18 are preferably comprised of metal or metal alloys which are durable enough to withstand the high temperatures and forces used during the rotational molding process. Additionally, while the aperture or opening 28 of the mold plate 16 and the platform or disc 38 of the arm plate 18 are shown and described as being circular, it is important to note that other shapes may be used without departing from the spirit or scope of the invention. Similarly, the bolts or rods 22 and the corresponding strike apertures 34 are seen as being cylindrical and semi-circular, respectively, however it should be noted that this is for illustrative purposes only. The bolts or rods 22 and the strike aperture 34 may comprise any number of different shapes or configurations, provided that the strike aperture 34 is capable of interacting or engaging with at least one of the bolts or rods 22.

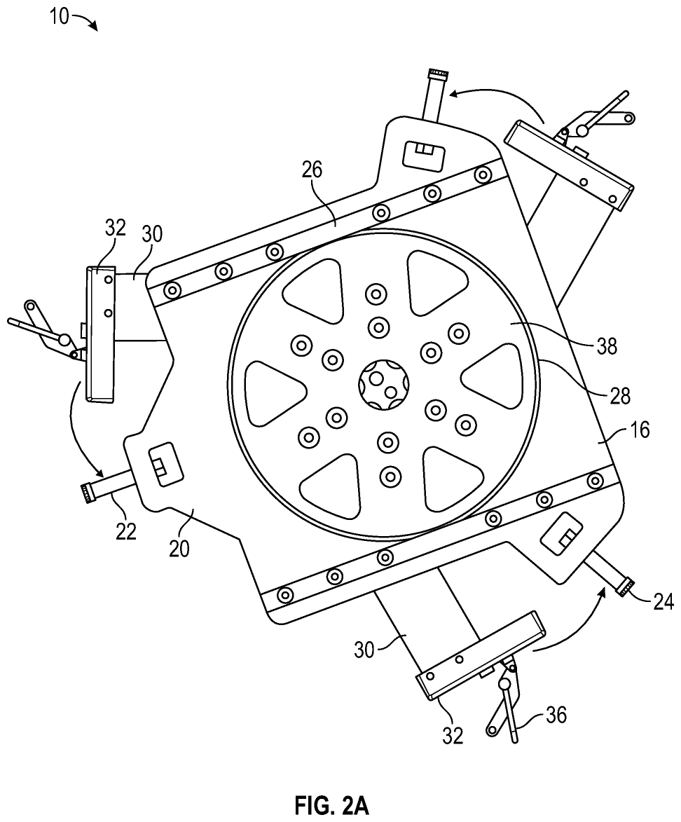

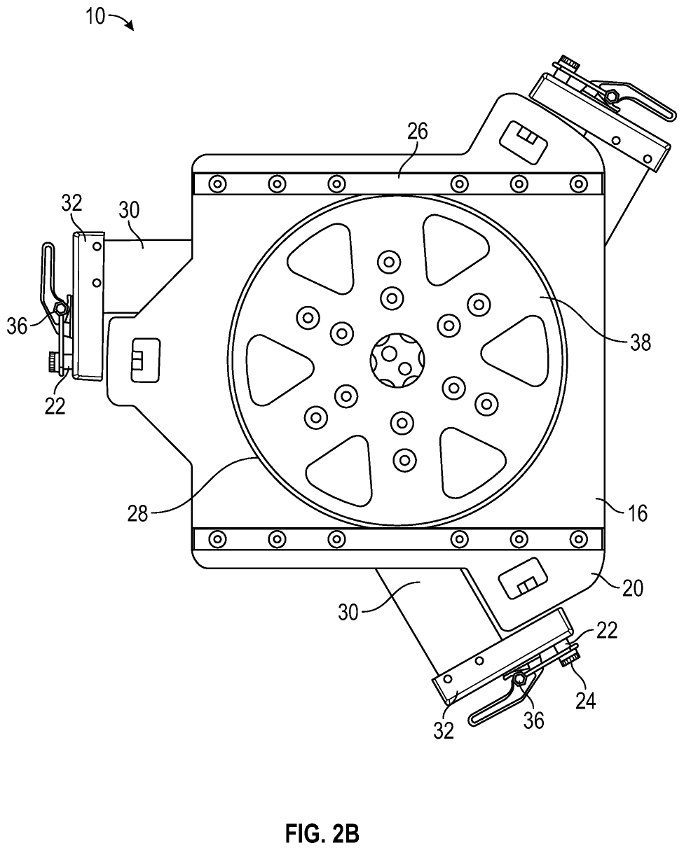

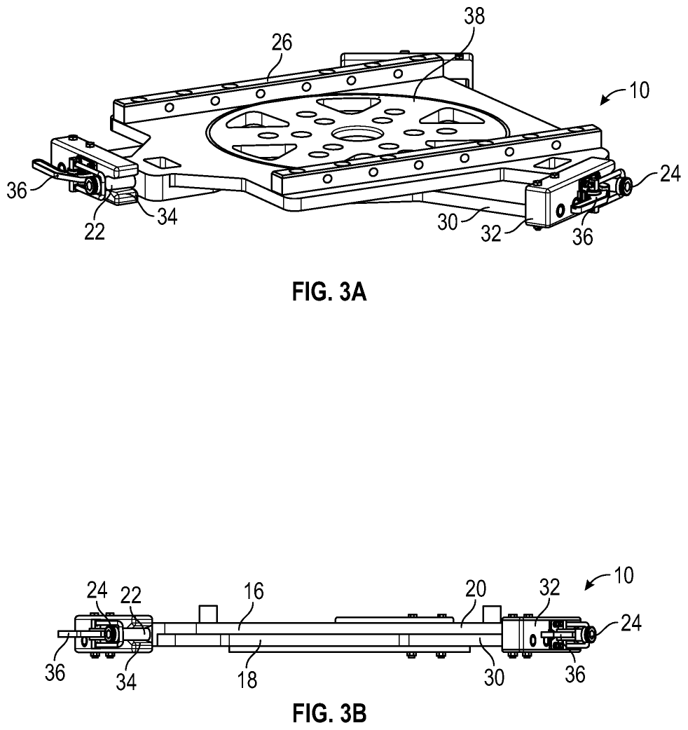

Detail of how the mold plate 16 interacts or engages with the arm plate 18 may be seen in FIGS. 2A-3B. Specifically, the mold plate 16 and the arm plate 18 are brought together with the platform or disc 38 of the arm plate 18 being inserted into the correspondingly shaped aperture or opening 28 of the mold plate 16. The aperture or opening 28 is sized so as to form a close fit with the platform or disc 38 without substantially increasing the coefficient of friction between the components. Additionally, silicone or another lubricant may be disposed between the outside edge of the platform or disc 38 and the inside surface of the aperture or opening 28 so as to maintain a low coefficient of friction. The mold plate 16 is placed on top of the arm plate 18 at an offset angle relative to each other as seen in FIG. 2A so that the bolts or rods 22 do not interfere or prematurely engage with the latches or receivers 32.

Once properly placed, the mold plate 16 is rotated with respect to the arm plate 18 so that the radial protrusions or spokes 20 of the mold plate 16 are brought into close proximity to the radial protrusions or spokes 30 of the arm plate 18. The mold plate 16 is continually rotated relative to the arm plate 18 until each of the bolts or rods 22 are firmly inserted or accommodated by a corresponding strike aperture 34 of an adjacent terminal or receiver 32. Each toggle clamp or coupling means 36 is then actuated by disposing a catch or clasp 42 over the cap or head 24 of the bolt or rod 22 then locking it into position using a lever 44 as seen in FIGS. 2B-3B. The mold plate 16 and the arm plate 18 are now securely coupled together and all further relative rotation between the mold plate 16 and arm plate 18 is prevented.

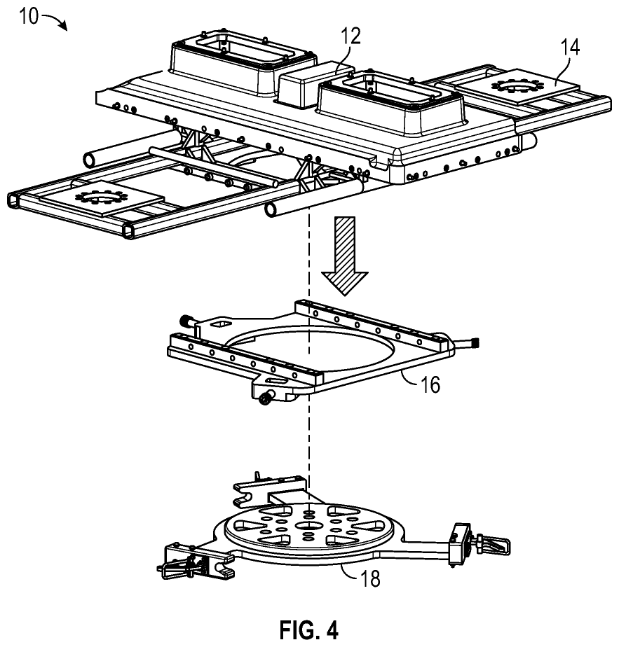

How the plate assembly 10 is implemented into a rotational molding apparatus and its associated use may be had by turning to FIG. 4. A mold 12 and mold frame 14 as are known in the art are first coupled to the mold plate 16. The mold plate 16 is brought into close proximity with either the mold frame 14 or the mold 12 itself with the preferably parallel orientated mounting brackets or rails 26 placed into contact with a designated surface of the mold frame 14 and/or the mold 14. Permanent coupling means such as bolts, screws, welds, rivets or other similar means are then used to permanently couple the mold plate 16 to the mold frame 14/mold 12. The arm plate 18 in turn is coupled to a machine outer arm of a rotational molding apparatus, specifically with the platform or disc 38 of the arm plate 18 in an upward facing orientation. The arm plate 18 is specifically coupled to a hub or other traditionally used means for rotating a mold within a rotational molding apparatus as is further detailed below.

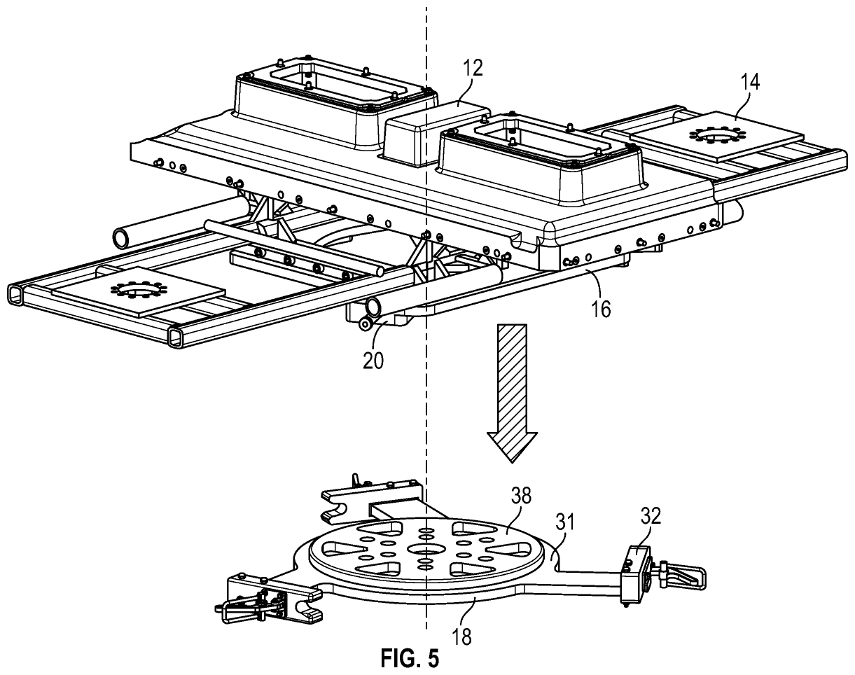

Next, the mold frame 14 comprising the mold plate 16 is then brought down on top of the arm plate 18 as seen in FIG. 5. The mold frame 14 is lowered onto the arm plate 18 so that the aperture or opening 28 of the mold plate 16 fits around or accommodates the platform or disc 38 of the arm plate 18, the mold plate 16 further being at an orientation that is initially rotated with respect to the arm plate 18 so that each of the bolts or rods do not prematurely engage or interact with the latches or receivers 32.

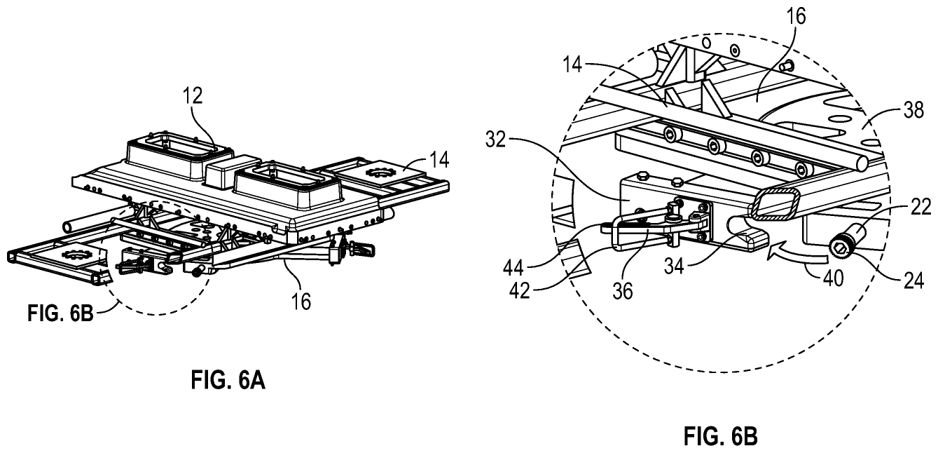

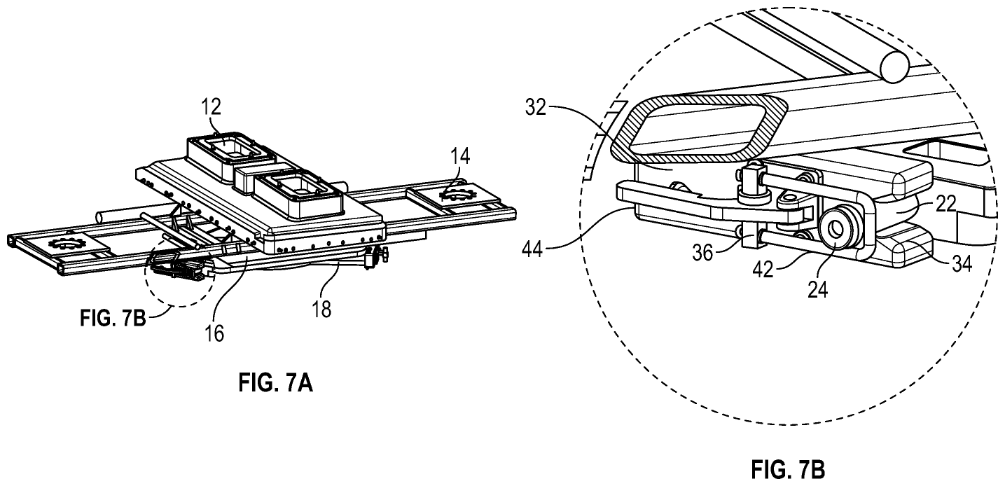

Once the platform or disc 38 is inserted within the mold plate 16, the mold plate 16 and the arm plate may be temporarily locked or coupled together. As seen in FIGS. 6A and 6B, the mold plate 16 is rotated with respect to the arm plate 16 by rotating the entire mold 12 and mold frame 14 so that the strike aperture 34 defined in each of the terminals or receivers 32 are brought into contact with a corresponding bolt or rod 22. The toggle clamp or coupling means 36 is preferably initially disposed in an open configuration so that when the bolt or rod 22 is brought against and then enters the strike aperture 34, the toggle clamp or coupling means 36 may then be brought down or actuated so as to lock or capture the bolt or rod 22 within the strike aperture 34 of the terminal or receiver 32. Specifically, as best seen in FIGS. 7A and 7B, the catch or clasp 42 is disposed over the enlarged cap or head 24 and then the lever 44 is actuated by being pushed against the terminal or receiver 32, thereby tightening or pulling the bolt or rod 22 against the rounded or hemispheric portion of the strike aperture 34. Due to the matching symmetrical layout of the arm plate 18 and the mold plate 16, each bolt or rod 22 simultaneously enters a corresponding strike aperture 34 of a corresponding latch or receiver 32. The locking process may then be repeated for the remaining toggle clamps or coupling means 36, thereby securing locking or fixing the mold plate 16 coupled to the mold frame 14 to the arm plate 18.

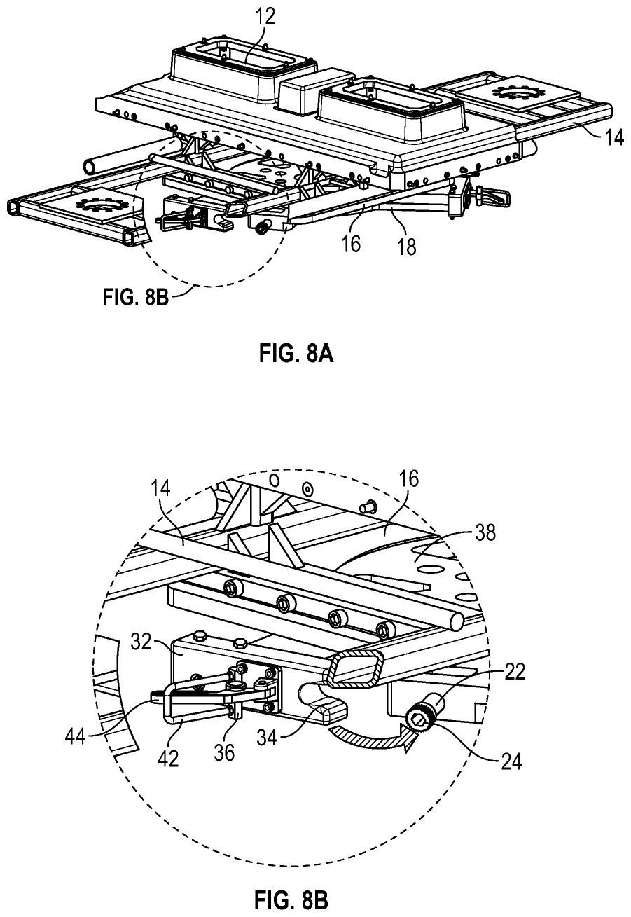

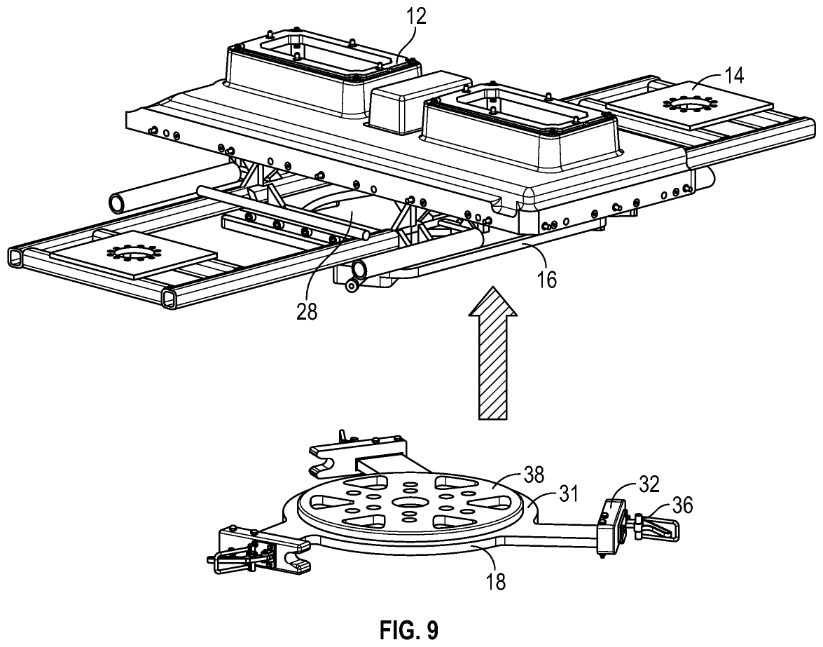

To decouple or remove the mold frame 14 and mold plate 16 from the arm plate 18, the lever 44 of each of the toggle clamps or coupling means 36 is actuated by being pulled away from the terminal or receiver 32 which is turn loosens or relaxes the clasp 42. The clasp 42 may then be taken off of the bolt or rod 22 and rotated away. As seen in FIGS. 8A and 8B, the arm plate 18 is then free to be rotated with respect to the mold plate 16, again with the platform or disc 38 of the arm plate 18 rotating within the aperture or opening 28 defined within the mold plate 16. As the arm plate is rotated, each corresponding bolt or rod 22 is moved out of its respective strike aperture 34. After the bolt or rod 22 is clear of the strike aperture 34 and terminal or receiver 32, the mold 12 and mold frame 14 may be lifted from the arm plate 18 as best seen in FIG. 9, with the platform or disc 38 of the arm plate 18 being removed from the opening or aperture 28 of mold plate 16.

With the mold 12 and mold frame 14 removed, a new or different mold and mold frame comprising its own corresponding mold plate 16 may then be coupled to the arm plate 18. Alternatively, after the mold frame 14 has been decoupled from the arm plate 18, the specific mold 12 may be removed from the mold frame 14 and then replaced by a new or different mold. The mold frame 14 comprising the new mold may then be recoupled to the arm plate 18 as detailed above. In this manner, the manufacturer may repeatedly replace or change out molds as needed while still using the same permanent arm plate 18, thereby increasing the efficiency of the overall rotational molding process. Additionally, because the mold frame 14 is removably coupled to the arm plate 18 via a relatively straightforward rotation and locking process, the safety of the workers tasked with operating the rotational molding machine is enhanced as opposed to the current means which require the mold to be bolted or unbolted to the rotational arm every time a mold needs to be replaced.

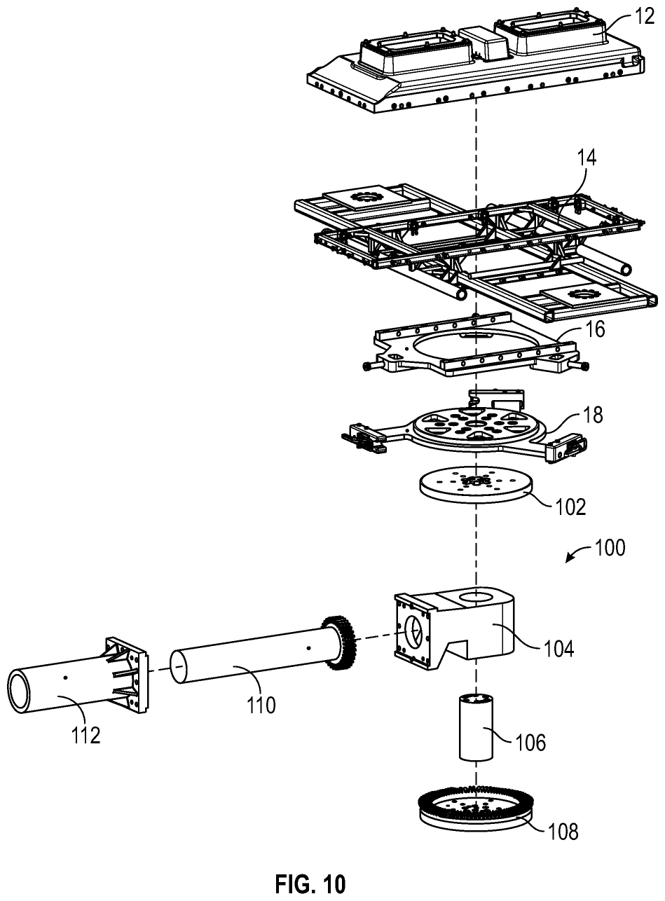

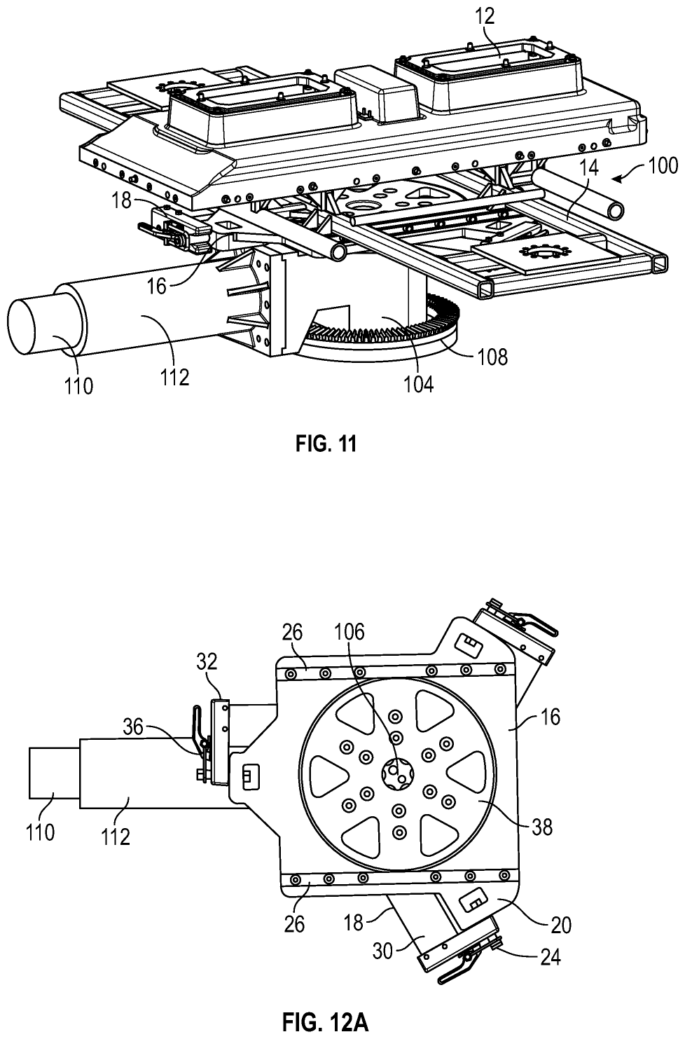

Great detail of how the mold plate 16 and the arm plate 18 interact or are applied to form a rotational molding assembly 100 may be seen in FIGS. 10 and 11. As seen in the exploded view of FIG. 10, the arm plate 18 is coupled to an arm hub 102 which in turn is coupled to an axle 106 disposed within a housing 104. The arm plate 18 is coupled to the arm hub 102 by inserting a plurality of bolts, screws, or other coupling means through a corresponding plurality of holes or apertures defined through the raised platform or disc 38 portion of the arm plate 18 and into a matching plurality of holes defined in the arm hub 102. A gear hub 108 is also coupled to the axle 106, thereby providing the axle 106, the arm hub 102, and the arm plate 18 the ability to rotate around a lateral or y-axis of the rotational molding assembly 100. Also coupled to the housing 104 is an outer arm 112 and a cylinder gear 110 disposed therethrough which provides the rotational molding assembly 100 the ability to further rotate around a horizontal or x-axis. The gear hub 108 and the cylinder gear 110 are further coupled to a power source by means known in the art so that the rotational molding assembly 100 may be simultaneously rotated about its vertical and/or horizontal axes as required by the rotational molding process.

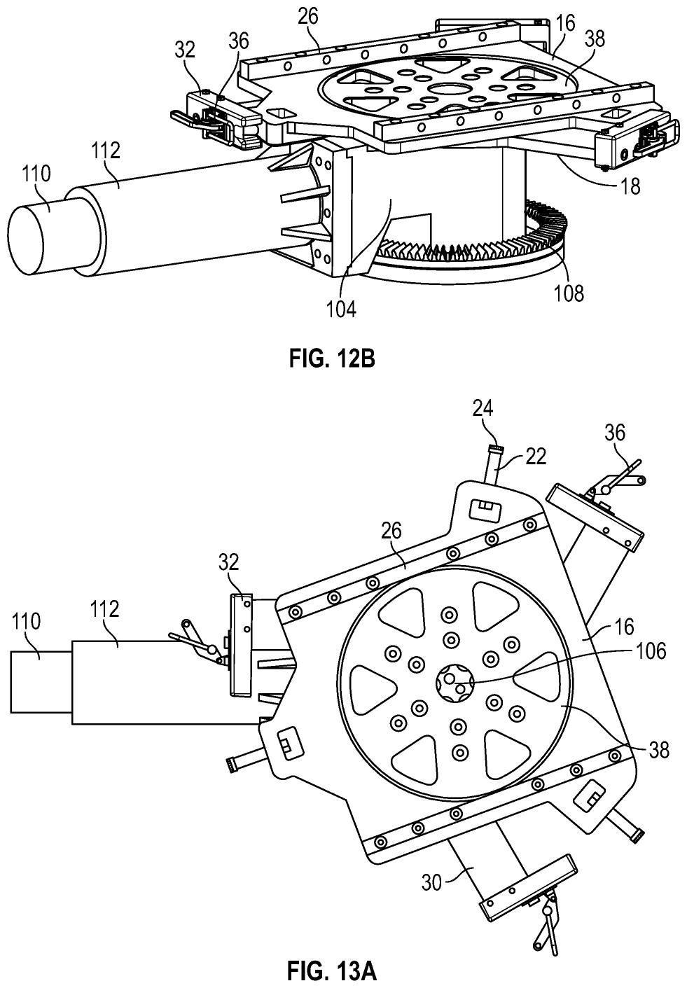

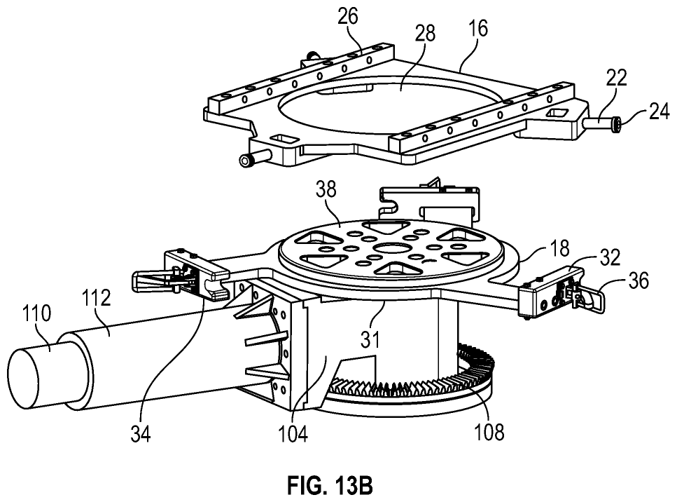

Turning to FIGS. 12A-13B, detail of how the plate assembly 10 operates while coupled to the rotational molding assembly 100 may be seen. The mold 12 and mold frame 14 have been removed from the drawings for clarity, however it should be noted that because the mold frame 14 is permanently coupled to the mold plate 16 via the pair of mounting brackets or rails 26, the mold 12 and mold frame 14 rotate along with the mold plate 16 as detailed below.

FIG. 12A and 12B show a top down view and a perspective view, respectively, of the plate assembly 10 when coupled to the rotational molding assembly 100, namely when the mold plate 16 is coupled to the arm plate 18 via the plurality of toggle clamps or other coupling means 36. Therefore, when the cylinder gear 110 rotates around its longitudinal axis, the rotational molding assembly 100 itself along with the coupled mold plate 16 will also rotate around its longitudinal axis. As is further seen, the axle 106 is engaged with an internal surface of a circular aperture defined substantially in the center of the raised platform or disc 38 portion of the arm plate 18 as well as the arm hub 102 (not seen). When the gear hub 108 is rotated, the axle 106 as well as the arm plate 18 will then rotate in the same direction. Because the mold plate 16, and by extension the mold 12 and mold frame 14, are coupled to the arm plate 16 as seen in FIGS. 12A and 12B, the mold plate 16 will in turn rotate along with the arm plate 18 coaxially around its lateral axis. In other words, the coupling between the mold plate 16 and the arm plate 18 permits the mold 12 portion of the rotational molding assembly 100 to spin, rotate, or traverse in any direction dictated by the movement of both the cylinder gear 110 and the gear hub 108.

When the mold 12 needs to be recharged, exchanged, or removed from the rotational molding assembly 100, each of the toggle clamps or coupling means 36 are actuated into an open position and the mold 12 and mold frame 14 comprising the mold plate 16 are rotated with respect to the arm plate 18 coupled to the housing 104 and outer arm 112 as seen in FIG. 13A and 13B. After the bolts or rods 22 of the mold plate 16 are removed from the strike apertures 34 of the corresponding receivers 32, the mold plate 16, and by extension the mold 12 and mold frame 14, will no longer rotate coaxially with the arm plate 18. Instead, should the gear hub 108 and axle 106 be actuated, the raised platform or disc 38 of the arm plate 18 will rotate within the aperture 28 of the mold plate 16 without rotating the mold plate 16 itself. The mold plate 16 may then be lifted or removed from the arm plate 18 and the rest of the rotational molding assembly 100 as seen in FIG. 13B.

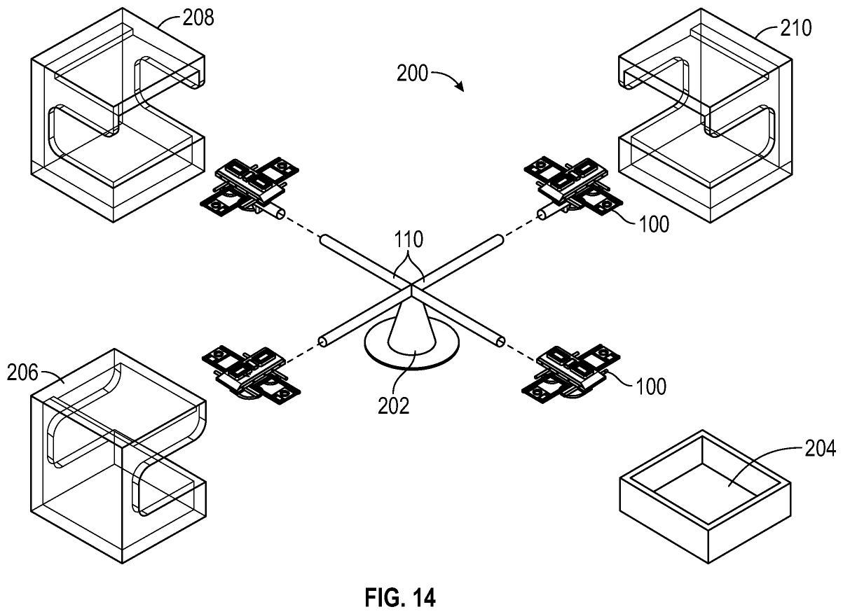

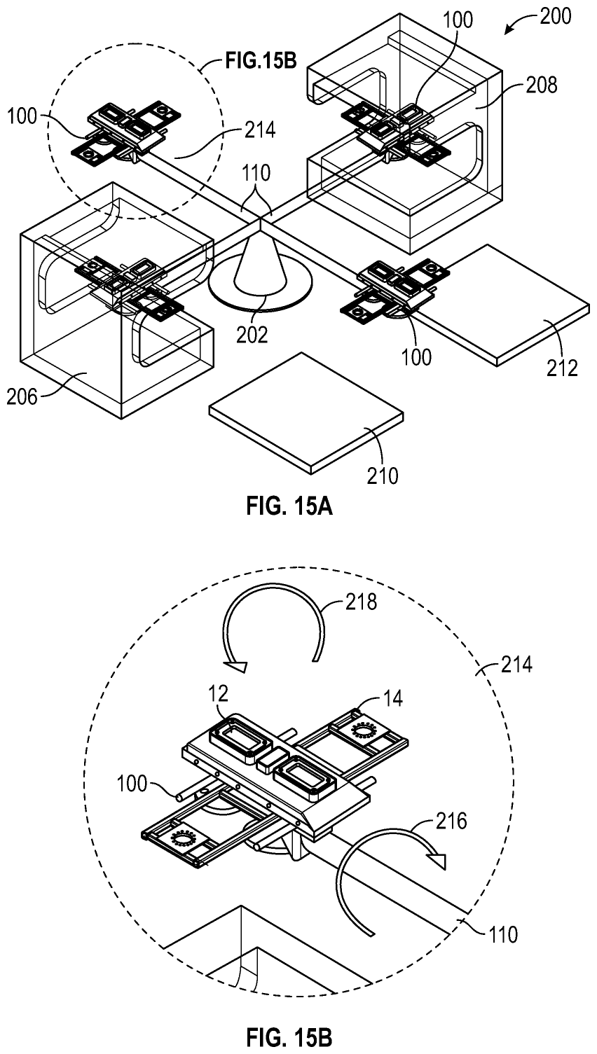

How the plate assembly 10 may be used in the overall rotational molding process may be seen by turning to FIGS. 14-15B. The rotational molding machine 200 comprises a central hub or indexing unit 202 which comprises a plurality of cylindrical gears 110 coupled to a common component or unit, with each of the plurality of cylindrical gears 110 comprising a rotational molding assembly 100 disposed on a distal end thereon. The central hub or indexing unit 202 comprises means for rotating each the rotational molding assemblies 100 between a plurality of stations or fabrication steps that constitute the rotational molding process.

In one embodiment seen in FIG. 14, the rotational molding machine 200 comprises a load/unload station 204, an oven or heating means 206, a first cooler or cooling means 208, and a second cooler or cooling means 210. The plurality of stations or fabrication steps are preferably disposed or orientated symmetrically about the central hub or indexing unit 202 so that each rotational molding assembly 100 may be sequentially moved between each station or fabrication step, with rotational molding assemblies 100 automatically moving from a final station or fabrication step and returning to a first station or fabrication step in order to repeat the manufacturing process.

First, at the load/unload station 204, an initially empty mold 12 is charged or filled with a predetermined type, color, and amount of granulated plastic as dictated by the item to be manufactured by the mold 12. One or more users with the assistance of a small crane or other lifting device then lift the mold 12 and mold frame 14 and couple them to an arm plate 18 disposed on the distal end of one of the cylindrical gears 110 as discussed above, namely by bringing the mold plate 16 coupled to the mold frame 14 into contact with the arm plate 18 and then slightly rotating the mold plate 16 so that the arm plate 18 may first engage and then be locked to the mold plate 16.

With the mold 12 and mold frame 14 firmly and safely secured to the first cylindrical gear 110, the central hub or indexing unit 202 rotates or indexes in a clockwise direction so that the now formed rotational mold assembly 100 is brought into the oven or heating means 206. As the heat from the oven or heating means 206 begins to melt the granulated plastic within the mold 12, the central hub or indexing unit 202 begins to rotate the rotational mold assembly 100 along a primary rotation axis 216 and a secondary rotation axis as seen in FIG. 15B, namely its longitudinal and lateral axes so as to spread or coat the melting plastic around the internal surfaces of the mold 12. Meanwhile, at the load/unload station 202, a second or additional rotational mold assembly 100 is coupled to a subsequent cylindrical gear 110 by coupling the mold 16 to the arm plate 18 as detailed above.

The central hub or indexing unit 202 and the plurality of cylindrical gears 110 are configured to spin or rotate the rotational mold assemblies 100 along their respective primary and secondary axes 216, 218 as discussed above throughout the rotational molding process, however specific periods of one or more axes of rotation may be implemented according to a predetermined program or schedule.

After being sufficiently heated, the central hub or indexing unit 202 rotates again which removes the rotational mold assembly 100 from the oven or heating means 206 and brings it into a first cooler or cooling means 208. The cylindrical gear 110 continues to rotate the rotational mold assembly 100 along one or both of the primary and/or secondary rotation axes 216, 218 while it and the now liquid plastic within begin to cool. Next, the rotational mold assembly 100 is brought into a second cooler or cooling means 210 by the central hub or indexing unit 202 so as to provide further cooling to the rotational mold assembly 100. Meanwhile, each time the central hub or indexing unit 202 rotates the first rotational mold assembly 100 between the oven or heating means 206 and the first cooler or cooling means 208, or between the first cooler or cooling means 208 and the second cooler or cooling means 210, a subsequent rotational mold assembly 100 on a different cylindrical gear 110 is rotated into the oven or heating means 206 or the first cooler or cooling means 208 accordingly.

Finally, the central hub or indexing unit 202 indexes or rotates the rotational mold assembly 100 back to the load/unload station 204 where workers, with the assistance of a crane or other lift device, decouple or remove the mold 12 and mold frame 14 from the cylindrical gear 110 by actuating the toggle clamps or coupling means 36 disposed on the arm plate 18, rotating the mold plate 16 relative to the arm plate 18, and then lifting the mold 12 and mold frame 14 away. Once separated, the molded item may be removed from the mold 12 which then can be refilled or recharged with more granulated plastic so that that rotational molding process may be repeated. Alternatively, the mold 12 and mold frame 14 once removed may be quickly and easily replaced with a new or different mold when a different molded item is to be manufactured.

In an alternative embodiment seen in FIGS. 15A and 15B, the rotational molding machine 200 may comprise a both a loading station 210 and an unloading station 212 to allow for greater access to the rotational mold assembly 100 each time the mold 12 requires charging or removal of a molded item. In this embodiment, the rotational molding machine 200 further comprises an ambient cooling station or zone 214. The cylindrical gear 110 rotates the rotational mold assembly 100 along the primary and secondary axes 216, 218 in the ambient air which slowly begins to cool the liquid plastic and form a solid item within the mold 12 for a predetermined amount of time before it is then indexed into the cooler or cooling means 208 for further rapid cooling.

As can be seen from the above, every time the central hub or indexing unit 202 rotates each rotational mold assembly 100, a corresponding mold 12 may be removed from the arm plate 18 as discussed above so that the newly molded item may be removed and fresh plastic may then be added to repeat the process. Because operation of the plate assembly 10 is fast, easy, and does not require individuals to remove fixtures such as bolts in order to couple and decouple a mold 12 from the rest of the rotational mold assembly 100, the overall time for production of manufacturing any number of plastic items is reduced without compromising the individual's safety.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings.

Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

We claim:

1. An apparatus for coupling a mold to a rotational molding machine comprising:
an arm plate; and
a mold plate configured to accommodate and rotate about a raised portion of the arm plate removably disposed within a body of the mold plate,
where the arm plate comprises a plurality of manual coupling means configured to selectively lock the mold plate to the arm plate.

2. The apparatus of claim 1 where the raised portion of the arm plate comprises a raised platform and where the mold plate comprises an opening defined within the body of the mold plate configured to accommodate the raised platform of the arm plate.

3. The apparatus of claim 1 further comprising:
a plurality of rods symmetrically disposed on the body of the mold plate; and
a plurality of receivers symmetrically disposed on the arm plate, each of the plurality of receivers comprising at least one of the manual coupling means disposed thereon,
wherein each of the plurality of receivers comprises a strike aperture defined therein configured to accommodate at least one of the plurality of rods.

4. The apparatus of claim 1 where each of the plurality of manual coupling means comprises a lever and a clasp, where the clasp is configured to capture the mold plate.

5. The apparatus of claim 1 where the mold plate comprises at least one mounting bracket configured to couple the mold plate to a mold frame and/or a mold.

6. The apparatus of claim 1 where the arm plate comprises means for coupling to a distal end of a rotational arm of the rotational molding machine.

7. A rotational molding apparatus comprising:
a mold;
an indexing unit comprising at least one rotational arm;
a mold plate coupled to the mold; and
an arm plate coupled to a distal end of the at least one rotational arm,
where the mold plate comprises means for selectively engaging the arm plate in order to couple the mold to the at least one rotational arm.

8. The rotational molding apparatus of claim 7 where the means for selective engaging the arm plate in order to couple the mold to the at least one rotational arm comprises:
an aperture defined within a body of the mold plate; and
a raised platform disposed on the arm plate, the raised platform configured to fit within the opening defined in the body of the mold plate,
where the mold plate is configured to rotate relative to the arm plate when the raised platform is disposed within the aperture.

9. The rotational molding apparatus of claim 7 where the means for selectively engaging the arm plate in order to couple the mold to the at least one rotational arm comprises:
a plurality of rods disposed on the mold plate;
a plurality of receivers disposed on the arm plate, each of the plurality of receivers comprising a strike aperture defined therein; and
a manual coupling means disposed on each of the plurality of receivers,
where the strike aperture defined in each of the plurality of receivers is configured to accommodate at least one of the plurality of rods therein.

10. The rotational molding apparatus of claim 9 where the manual coupling means comprises a toggle clamp.

11. The rotational molding apparatus of claim 9 where both the plurality of rods and the plurality of receivers are symmetrically disposed around the mold plate and the arm plate, respectively.

12. The rotational molding apparatus of claim 10 where the toggle clamp comprises a clasp configured to fit around a head of at least one of the plurality of rods.

13. The rotational molding apparatus of claim 9 where the plurality of rods and the plurality of receivers extend radially from a body of the mold plate and a body of the arm plate, respectively.

14. The rotational molding apparatus of claim 7 where the mold and mold plate are configured to rotate around a primary axis and a secondary axis when the mold plate is selectively engaged with the arm plate.

15. A method for coupling a mold to a rotational molding machine comprising:
disposing a mold plate coupled to a mold over an arm plate coupled to a distal end of at least one rotational arm of the rotational molding machine;
inserting a platform disposed on the arm plate into an aperture defined in a body of the mold plate;
rotating the mold plate relative to the arm plate; and
locking the mold plate to the arm plate.

16. The method of claim 15 where rotating the mold plate relative to the arm plate comprises rotating the body of the mold plate around a circumference of the platform disposed on the arm plate.

17. The method of claim 15 where rotating the mold plate relative to the arm plate comprises rotating a plurality of rods radially disposed on the body of the mold plate relative to the arm plate.

18. The method of claim 17 where rotating the plurality of rods radially disposed on the body of the mold plate relative to the arm plate comprises rotating the plurality of rods into a corresponding plurality of receivers disposed on the arm plate.

19. The method of claim 18 where rotating the plurality of rods into the corresponding plurality of receivers disposed on the arm plate comprises inserting each of the plurality of rods into an aperture defined in each of the plurality of receivers.

20. The method of claim 18 where locking the mold plate to the arm plate comprises actuating a coupling means disposed on each of the plurality of receivers after rotating the mold plate relative to the arm plate.

21. The method of claim 19 where actuating the coupling means disposed on each of the plurality of receivers after rotating the mold plate relative to the arm plate comprises accommodating each of the plurality of rods with a clasp disposed on each of the plurality of receivers and then maintaining the plurality of rods in a fixed position relative to the plurality of receivers.

22. The method of claim 15 further comprising coupling the mold plate to a mold frame.

23. A method for manufacturing an item using a rotational molding machine comprising:
charging a mold with granulated plastic;
disposing a mold plate coupled to the mold on top of an arm plate coupled to a distal end of a rotational arm of a rotational molding machine;
rotating the mold relative to the rotational arm in a first direction;
actuating a coupling means disposed on the arm plate which locks the mold plate to the arm plate;
heating the mold while rotating the mold along a primary axis and a secondary axis;
cooling the mold while rotating the mold along the primary axis and the secondary axis; and
removing the item from the rotational molding machine.

24. The method of claim 23 where disposing the mold plate coupled to the mold on top of the arm plate coupled to the distal end of a rotational arm of the rotational molding machine comprises:
aligning an aperture defined in a body of the mold plate over a platform disposed on the arm plate; and
inserting the platform disposed on the arm plate into the aperture defined in the body of the mold plate.

25. The method of 24 where rotating the mold relative to the rotational arm in the first direction comprises rotating the body of the mold plate around a circumference of the platform of the arm plate.

26. The method of claim 24 where rotating the mold relative to the rotational arm comprises inserting a plurality of rods disposed on the mold plate into a corresponding plurality of receivers disposed on the arm plate as the mold plate is rotated relative to the arm plate.

27. The method of claim 23 where actuating the coupling means disposed on the arm plate which locks the mold plate to the arm plate comprises actuating a plurality of toggle clamps.

28. The method of claim 24 where actuating the coupling means disposed on the arm plate comprises:
inserting each of the plurality of rods into a strike aperture defined in each of the corresponding plurality of receivers;
disposing a clasp disposed on each of the plurality of receivers around each of the plurality of rods; and
tightening the clasp disposed on each of the plurality of receivers against a surface of each of the plurality of receivers.

29. The method of claim 23 where removing the item from the mold comprises:
actuating the coupling means disposed on the arm plate which unlocks the mold plate from the arm plate;
rotating the mold relative to the rotational arm in a second direction;
lifting the mold plate from the arm plate; and
removing the item from the mold.

30. The method of claim 29 where lifting the mold plate from the arm plate comprises removing a platform disposed on the arm plate from an aperture defined within a body of the mold plate.
